(19) United States
(12) Patent Application Publication
(10) Pub. No.: US 2023/0275758 A1
(43) Pub. Date: Aug. 31, 2023

(54) REPROGRAMMABLE PROCESSING DEVICE ROOT KEY ARCHITECTURE

(71) Applicant: Intel Corporation, Santa Clara, CA (US)

(72) Inventor: Matthew Areno, Round Rock, TX (US)

(73) Assignee: Intel Corporation, Santa Clara, CA (US)

(21) Appl. No.: 18/312,838

(22) Filed: May 5, 2023

Related U.S. Application Data
(60) Provisional application No. 63/388,578, filed on Jul. 12, 2022.

(51) Int. Cl. H04L 9/08; H04L 9/06

(52) U.S. Cl. CPC H04L 9/0894; H04L 9/0869; H04L 9/0631

(57) ABSTRACT

A processing device includes a non-volatile memory (NVM), provisioning circuitry to receive a provision key and provision data encrypted with the provision key, and to store the encrypted provision data in the NVM, exclusive-OR (XOR) circuitry to perform an XOR operation on the provision key and a physically unclonable function (PUF) mask to generate a masked provision key, and encryption circuitry to encrypt the masked provision key with a PUF key to generate an encrypted provision key. The provisioning circuitry is to store the encrypted provision key in the NVM.

### CROSS-REFERENCE TO RELATED APPLICATION

This application claims the benefit of U.S. Provisional Patent Application No. 63/388,578, filed Jul. 12, 2022, which is incorporated by reference herein in its entirety.

### FIELD OF THE DISCLOSURE

This disclosure relates generally to security in computing systems, and more particularly, to reprogrammable root keys in processing devices of computing systems.

### BACKGROUND

A root key is used in modern processor architectures of computing systems serve as the basis for measurement, trust, and attestation of security within processing devices. Traditionally, the root key is hard-coded into some form of non-volatile (NV), one-time-programmable (OTP) memory, such as register-transistor logic (RTL) circuitry, electrical fuses, or a read-only memory (ROM). However, this results in security concerns because the root key has been shown time and time again to be susceptible to extraction from either physical attacks or insider threats. The consequences of extraction of the root key ranges from significant to disastrous.

Further, many customers wish to control their own identity in computing systems, both for initial provisioning of identity information as well as for removal of that information after they are done using the computing systems. Hard-coded information, whether programmed by a processor manufacturer, an original equipment manufacturer (OEM) or original device manufacturer (ODM), or an end user, cannot be removed. As such, existing solutions dependent upon hard-coded values stored in fuses in processing devices of computing systems are not compliant with such needs.

### BRIEF DESCRIPTION OF THE DRAWINGS

FIG. 1 illustrates a reprogrammable processing device root key architecture according to an implementation.

FIG. 2 is a flow diagram of key provisioning processing in an implementation.

FIG. 3 illustrates a provisioning counter architecture according to an implementation.

FIG. 4 is a flow diagram of boot processing of a computing system including a reprogrammable processing device root key architecture in one example.

FIG. 5 is a block diagram of an example processor platform structured to execute and/or instantiate the machine-readable instructions and/or operations of FIGS. 1-4 to implement the apparatus discussed with reference to FIGS. 1-4.

FIG. 6 is a block diagram of an example implementation of the processor circuitry of FIG. 5.

FIG. 7 is a block diagram of another example implementation of the processor circuitry of FIG. 5.

FIG. 8 is a block diagram illustrating an example software distribution platform to distribute software such as the example machine readable instructions of FIG. 5 to hardware devices owned and/or operated by third parties.

The figures are not to scale. In general, the same reference numbers will be used throughout the drawing(s) and accompanying written description to refer to the same or like parts.

### DETAILED DESCRIPTION

The technology described herein provides a processing device architecture that provides the ability to re-create a processing device owner-defined root key. Using a finite state machine (FSM) (whether implemented in hardware, firmware or software), together with fuses and a small amount of non-volatile, rewriteable memory, a technique is presented herein to provision an initial processing device root key for a processing device (such as a processor, for example) in a computing system, while also allowing the processing device owner to reprogram, or reprovision, part of the key with the processing device owner's device specific information. Device specific information is stored in the non-volatile, rewriteable memory location, encrypted with the owner defined key, and removed from any permanent storage on the processing device.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections.

As used herein, “processor” or “processing device” or “processor circuitry” or “hardware resources” are defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor, processor circuitry and processing devices include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s). As used herein, a device may comprise processor circuitry or hardware resources.

As used herein, a computing system can be, for example, a server, a personal computer, a workstation, a self-learning machine (e.g., a neural network), a mobile device (e.g., a cell phone, a smart phone, a tablet (such as an iPad™)), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

Existing methods for storing root keys mostly rely upon hard-coded values stored in OTP memory. Newer processing device architectures have begun to incorporate physically unclonable function (PUF) circuitry as a method of creating a unique, but deterministically reproducible, value. This value is then used either directly as a root key or is fed into a key-derivation function that outputs the root key.

For identity, a similar approach is used wherein a unique-per-device value is stored in OTP memory. A common solution being adopted today is defined by the Trusted Computing Group (TCG) Device Identity Composition Engine (DICE) specification. A chain of identities can be created throughout the boot sequence of the computing system that are all a “root” in the unique-per-device value. The specification allows for the operating system vendor (OSV) or end-user to influence some, but not all, identity values.

Use of a hard-coded value in OTP memory has been shown repeatedly to be a significant, and unnecessary, security risk. The move to PUFs is certainly a move in the right direction, but still does not provide flexibility, re-programmability, or control to the end user (e.g., the owner of the processing device and/or the computing system). The PUF cannot be revoked or changed, and usage of the PUF in cryptographic operations or key-derivation processes exposes the PUF to unnecessary risk of extraction.

With respect to identities, static identities have clear limitations for revoking or changing the identity, as well as not allowing the owner the ability to modify the identity or introduce a new identity. Even in implementations such as TCG DICE, the OSV or end-user (or owner) only has the ability to indeterminately modify the value as opposed to setting the identity to a specific value. This modification also does not remove any prior identities derived during earlier stages of the boot sequence.

In contrast, the technology presented herein provides the ability to remove unnecessary dependence and risk associated with one or more static device root keys stored in OTP on a processing device in a computing system. Further, the technology allows for processing device owners to provision their own provisioning information (including identity information) on a processing device in a computing system. Further, this technology allows for easy removal of owner information prior to retirement or sale of the processing device or the computing system (including the processing device) by the owner.

The technology disclosed herein provides an ability to re-create an externally generated key within a processing device, a mechanism to split processing device specific information between two non-volatile memory elements, one of which must be rewriteable, and an owner accessible interface to the mechanism within the processing device allowing the owner to securely upload their provisioning information for secure regeneration and secure storage within the provisioning device.

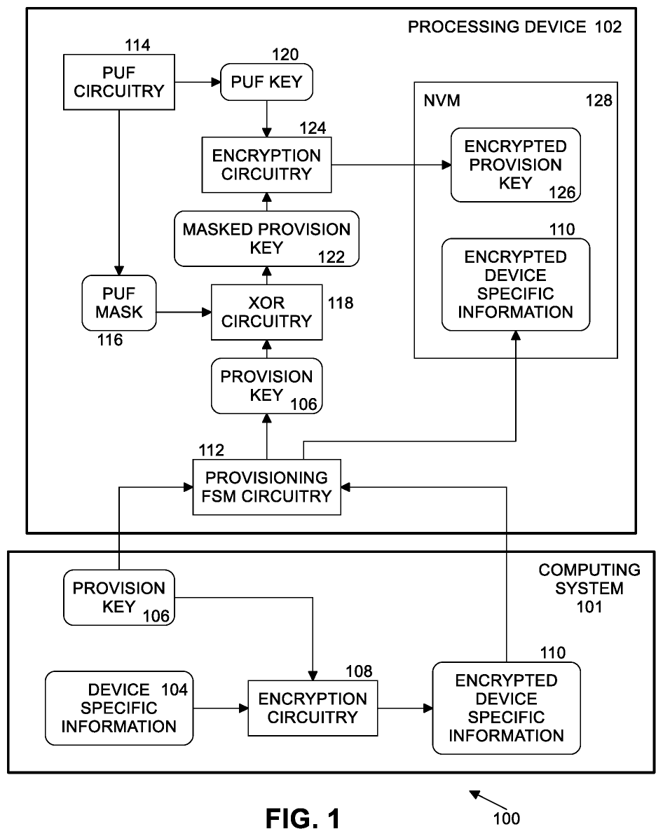

FIG. 1 illustrates a reprogrammable processing device root key architecture 100 according to an implementation. Root key architecture 100 includes a computing system 101 and a processing device 102. In an implementation, computing system 101 includes processing device 102. Computing system 101 may be operated by a customer, user, owner, OEM, system manufacturer, etc., denoted “customer” herein. In an example, the customer may be the purchaser of the processing device for inclusion of the processing device into a computing system operable to perform data processing. For example, the processing device may be a processor. The customer may desire to insert a customer-generated provision key 106 to act as a root key for computing system 101, as well as customer-generated device specific information 104 describing and/or identifying the processing device. For example, device specific information 104 may include one or more of a device identifier (ID) (e.g., processor ID, central processing unit (CPU) ID, and the like), device certificate hash value, device root key, and/or global firmware (FW) key. Other data items may also be included in device specific information 104 as needed.

In an implementation, provision key may be an Advanced Encryption Standard (AES) key. In other implementations, other methods of cryptography may be used for keys, encryption and decryption.

The customer's computing system 101 encrypts device specific information 104 by encryption circuitry 108 (e.g., AES encryption circuitry) using provision key 106 to generate encrypted device specific information 110. In an implementation, encryption circuitry 108 may include or be a part of a hardware (HW) security module (HSM). Computing system 101 provides provision key 106 and encrypted device specific information 110 to provisioning FSM circuitry 112 of processing device 102 during the provisioning process for a computing system (which may or may not be computing system 101).

Note that since the customer generates provision key 106 and device specific information 104, the customer loads the provision key 106 into the processing device only during provisioning by the customer (e.g., after delivery of the processing device from the manufacturer of the processing device to the customer), and the device specific information is only stored in encrypted form within processing device 102, the customer may be assured that a manufacturer of the processing device does not have access to the customer's generated provision key 106 and device specific information 104.

In an implementation, processing device 102 is powered on by the customer during the provisioning process and PUF circuitry 114 generates a random bit string. In an example, the random bit string may be divided into two portions, a (symmetric) PUF key 120 portion and a PUF mask 116 portion. The size of the random bit string, the PUF key 120 and the PUF mask are implementation dependent (e.g., 512 bits, 1,024 bits, 2,048 bits, etc.). In at least one implementation, the number of bits of the PUF key 120 is the same as the number of bits of the PUF mask 116. In another implementation, the number of bits of the PUF key 120 is different than the number of bits of the PUF mask 116. In at least one implementation, the number of bits of the PUF key 120 is the same as the number of bits of the provision key 106. In an implementation, PUF key 120 is used as a cryptographic key and PUF mask 116 is used as exclusive-OR (XOR) mask bits. In another implementation, true random number generator (TRNG) circuitry may be used instead of PUF circuitry 114. XOR circuitry 118 in processing device 102 performs an XOR operation on provision key 106 and PUF mask 116 to generate masked provision key 122. In an example, masked provision key 122 thus comprises a random key split.

In an implementation, PUF circuitry 114 is used to generate a key “split”. A key split, as defined in National Institute of Standards and Technology (NIST) Special Publication 800-152 “A Profile for U.S. Federal Cryptographic Key Management Systems”, October 2015, and demonstrated in NIST Special Publication SP 800-133r1 “Recommendation for Cryptographic Key Generation”, June 2020, may be formed in one of several different ways. The method used here is a simple XOR operation (an approved method #3 as shown in section 6.6 of SP 800-133r1).

Given A⊗B=C, it follows that C⊗B=A.
A=Provision Key
B=PUF key split
C=New key Split

As shown, a portion of the PUF output may be used as a unique key split vector, which when XOR'd with the provision key 106 creates a new key split. Recombining the new key split with the key split from the PUF via an XOR operation returns the original provision key.

Encryption circuitry 124 (e.g., symmetric encryption circuitry) encrypts masked provision key 122 using PUF key 120 to generate encrypted provision key 126. Encryption circuitry 124 stores the encrypted provision key 126 in NVM 128 for use as needed in future cryptographic operations. Provisioning FSM circuitry 112 stores encrypted device specific information 110 in a non-volatile memory (NVM) 128 for use as needed in future cryptographic operations.

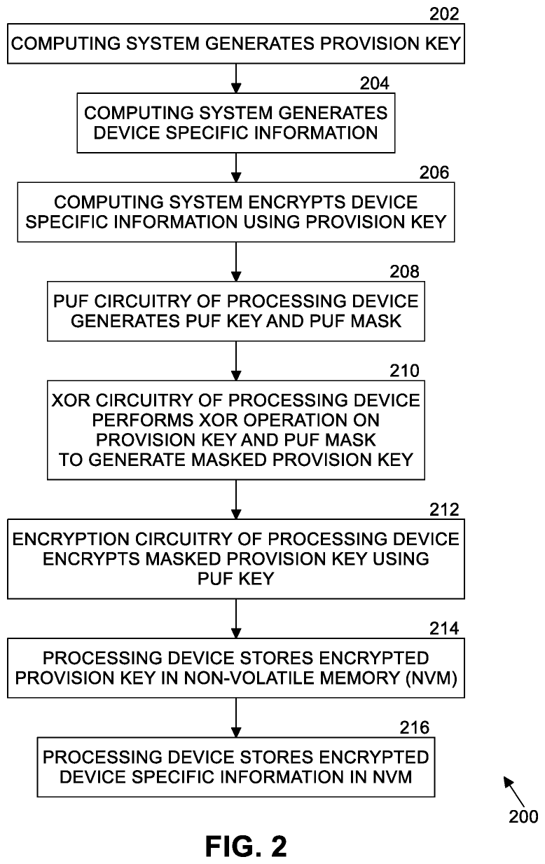

FIG. 2 is a flow diagram of key provisioning processing 200 in an implementation. At block 202, computing system 101 generates provision key 106. At block 204, computing system 101 generates device specific information 104. At block 206, computing system 101 encrypts device specific information 104 using provision key 105 to generate encrypted device specific information 110. The provision key and the encrypted device specific information are communicated to provisioning DSM circuitry 112 of processing device by any suitable means (e.g., pins, joint test action group (JTAG) connections, etc.).

When processing device 102 is powered on, at block 208 PUF circuitry 114 of processing device 102 generates PUF key 120 and PUF mask 116. At block 210, a masked provision key is generated from the provision key and the PUF mask. In an implementation, XOR circuitry 118 of processing device 102 performs an XOR operation on provision key 106 and PUF mask 116 to generate masked provision key 122. At block 212 encryption circuitry 124 of processing device 102 encrypts the masked provision key using PUF key 120 to generate encrypted provision key 126. At block 214, processing device 102 stores encrypted provision key 126 in NVM 128. At block 216, processing device 102 (e.g., provisioning FSM circuitry 112) stores encrypted device specific information 110 in NVM 128. Storage of encrypted device specific information 110 in NVM 128 may be performed at any time after receipt by processing device 102.

This process may be used to support reprogramming once processing device 102 is in the field (e.g., being used by a processing device owner (the customer)). While the processing device is still in the manufacturing phase and undergoing test and verification processing, key provisioning can be performed repeatedly (without limit) if block 214 is omitted. This allows the processing device manufacturer to perform all necessary tests of the processing device. A time-based delay between provisioning may be considered, even within the manufacturing phase, to prevent potential insider threats that might attempt to extract information about the output of the PUF circuitry 114 or TRNG via the provisioning process. Once manufacturing is completed, a separate fuse may be blown to signify that the processing device is fully provisioned and all subsequent provisioning should follow the processing of FIG. 2.

The technology described herein supports the ability to re-provision processing devices with new keys and device specific information. The technology minimizes supply chain security concerns since the keys can be replaced. The technology enables a soft tampering response with the capability of removing the PUF key and PUF mask bitstreams. Customer data (e.g., device specific information and provision key) may be stored in a separate partition of NVM 128 than provisioning data of the processing device manufacturer. In an implementation, the customer may remove the provisioning data of the processing device manufacturer and the processing device may default to using only customer-proved provisioning data.

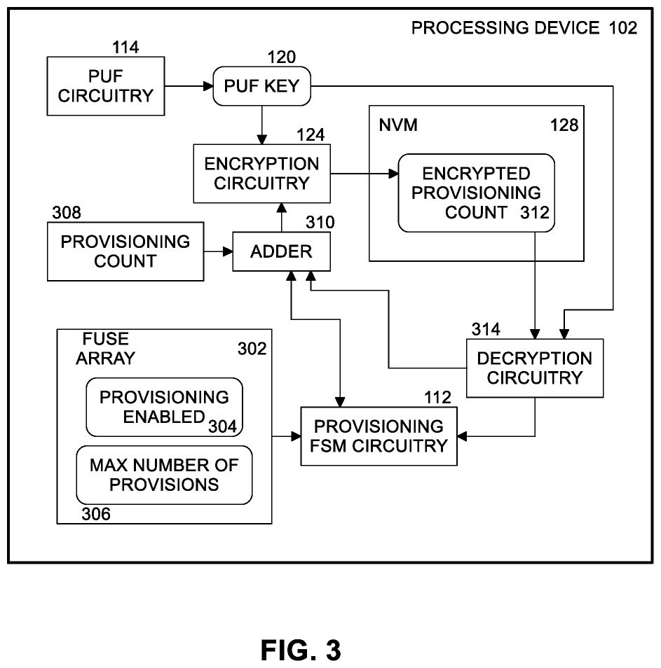

In addition to the functionality of reprovisioning a root key, the technology described herein may also include circuitry to control enablement and track execution of provisioning. This circuitry may be used by a manufacturer of the processing device to set a limit, during manufacturing, of the number of times a root key may be provisioned for the processing device. FIG. 3 illustrates a provisioning counter architecture according to an implementation. A provisioning count value 308 is used to maintain the total number of root key provisions that have been performed for processing device 102. The provisioning count value 308 is initially set to zero (e.g., by the manufacturer of processing device 102) and fed to adder 310 for incrementing after the first provisioning. The provisioning count value 308 may be encrypted by encryption circuitry 124 with PUF key 120 generated by PUF circuitry 114 (or other TRNG circuitry) to form encrypted provisioning count 312. Encrypted provisioning count 312 may then be stored in NVM 128. Each time processing device 102 is booted, the encrypted provisioning count 312 is decrypted by decryption circuitry 314 and made available for reading by the provisioning FSM circuitry 112. When a new key provisioning is performed, the provisioning count value is incremented, encrypted, and written over the previously stored encrypted provisioning count 312 in NVM 128. The provisioning count value 308 may not be written directly by a customer operating computing system 101.

To control enablement, a second form of non-volatile memory may be used in processing device 102, such as fuse array 302. In the fuse array 302, one or more fuses may be used to indicate that provisioning is allowed. In an implementation, a provisioning enabled value of fuse array 302 may be set by the manufacturer of the processing device. When enabled, provisioning may be performed. When disabled, provisioning may not be performed. A second set of fuses may be used to set a maximum (max) number of provisions 306 that may be performed on the processing device 102. When a provisioning request is received, provisioning FSM circuitry 112 checks the provisioning enabled value 304, and if enabled, compares the current provisioning count with the maximum number of provisions 306 indicated in the fuses in fuse array 302 to determine if provisioning may be performed.

In an alternative implementation, a provisioning control mechanism may use a reconfigurable logic technology. In this implementation, of a reconfigurable block of logic circuitry may be configured during each boot sequence. This block of logic circuitry may be used to create a custom provisioning enablement circuit controllable by the customer to restrict the ability of an attacker to maliciously enable and conduct a reprovisioning. Other control mechanisms may also be used.

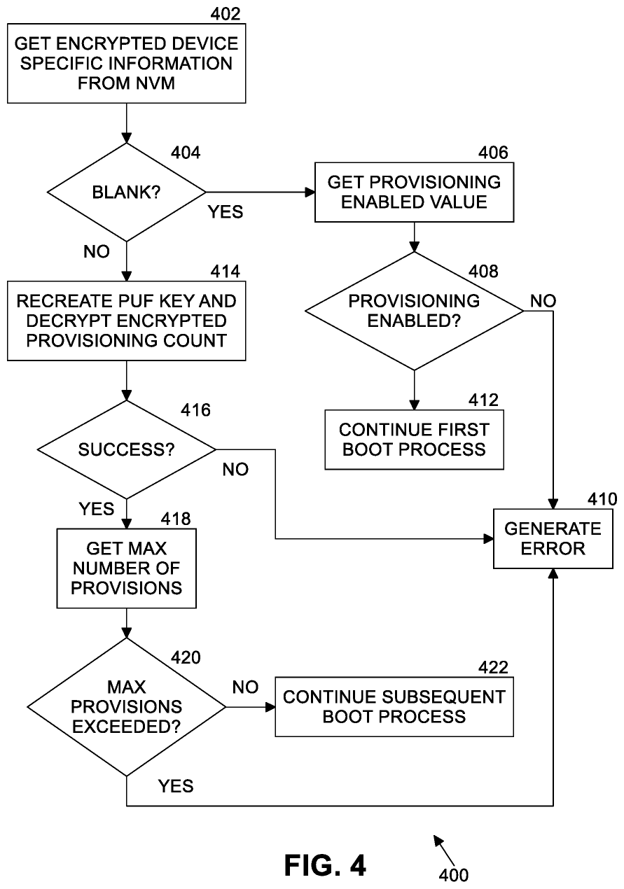

FIG. 4 is a flow diagram of boot processing 400 of a computing system including a reprogrammable processing device root key architecture in one example. These actions may be performed when a customer operating computing system 101 tries to provision a root key (e.g., provision key 106) into processing device 101. At block 402, the non-volatile memory (NVM) 128 is read by provisioning FSM circuitry 112 to get encrypted device specific information 110. If the encrypted device specific information is blank (e.g., zero or null) at block 404, then this is the first iteration of root key provisioning (e.g., a first boot process for loading provision key 106 into processing device 102). In this case, at block 406, provisioning FSM circuitry 112 reads fuse array 302 to get provisioning enabled value 304. If provisioning is enabled according to provisioning enabled value 304, then processing device 102 continues with the first boot process at block 412. If provisioning is not enabled, then an error is generated at block 410.

If the encrypted device specific information 110 read from NVM 128 is not blank at block 404, then this is a subsequent iteration of root key provisioning (e.g., a subsequent time the customer is provisioning provision key 106 into processing device 102 after a first provisioning). At block 414, PUF circuitry 114 recreates PUF key 120 and decryption circuitry 314 decrypts encrypted provisioning count 312 using PUF key 120. At block 414, if decryption of the encrypted provisioning count 312 is successful, then provisioning FSM circuitry 112 gets the maximum number of provisions 306 from fuse array 302 at block 418. If the max number of provisions for processing device 102 is exceeded at block 420, then an error is generated at block 410. Otherwise, the subsequent boot process is continued at block 422. At block 216, if decryption is unsuccessful, then an error is generated at block 210.

If manufacturer provisioned fuses in fuse array 302 have not yet been blown at block 206 or 218, processing device 102 is considered to still be in the manufacturing stage and provisioning is enabled by setting the provisioning enabled value 304 and the maximum number of provisions 306 (e.g., by blowing fuses).

The technology described herein allows end equipment owners, or OEMs, the ability to directly control the key material provisioned into processing devices, even after the processing device has exited the manufacturing process with initial key material. All known existing solutions are either shipped without being able to be provisioned by the original device manufacturer (ODM), or they do not allow the end equipment owners (e.g., customers or OEMs) the ability to directly control such key material. For instance, some existing solutions that use TCG DICE for device identity and key creation only allow owners (e.g., customers or OEMs) the ability to manipulate the key via injection of material into a key derivation function. This is not a direct manipulation of the resulting key as the owner (e.g., customer or OEM) only own a single portion of the input data into the key derivation function.

The technology described herein also eliminates supply chain risks by providing a key hierarchy that can be modified throughout the various supply chain stages but can also be completely replaced by the equipment owner (e.g., customer or OEM). All other known existing solutions are contingent upon immutable keys or key material, even those that are now moving to incorporate PUF technology. In the newer approaches that utilize PUFs, the resulting key hierarchy is still static. The PUF repeatedly outputs the exact same value, resulting in the same key hierarchy at all times.

Finally, the technology described herein includes a novel usage of the key output as an XOR-mask of an externally generated key (e.g., provision key 106) as opposed to an input into a key derivation function. All known existing usages of PUFs in these situations include either the use of the PUF output directly as a key or uses of the PUF output as an input vector into a key derivation function. Such approaches make the PUF output directly susceptible to side channel attacks on either the usage of the PUF output as a key for a cryptographic algorithm or as part of a key derivation function. The implementations described herein still use a first portion of the PUF as a key, but uses a second portion to generate a key split via an XOR operation. This make extractions of both portions of the PUF output significantly more difficult, thereby providing even greater protection of the provisioned key.

While an example manner of implementing the technology described herein is illustrated in FIGS. 1-4, one or more of the elements, processes, and/or devices illustrated in FIGS. 1-4 may be combined, divided, re-arranged, omitted, eliminated, and/or implemented in any other way. Further, the example improved computing system 101 may be implemented by hardware, software, firmware, and/or any combination of hardware, software, and/or firmware. Thus, for example, any portion or all of the improved computing system 101 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example hardware resources is/are hereby expressly defined to include a non-transitory computer readable storage device or storage disk such as a memory, a digital versatile disk (DVD), a compact disk (CD), a Blu-ray disk, etc., including the software and/or firmware. Further still, the example embodiments of FIGS. 1-4 may include one or more elements, processes, and/or devices in addition to, or instead of, those illustrated in FIGS. 1-4, and/or may include more than one of any or all the illustrated elements, processes and devices.

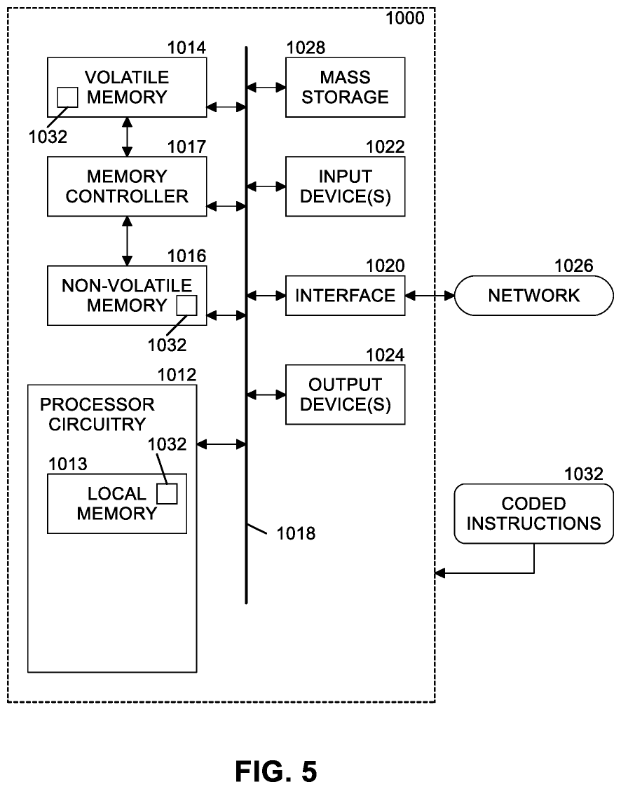

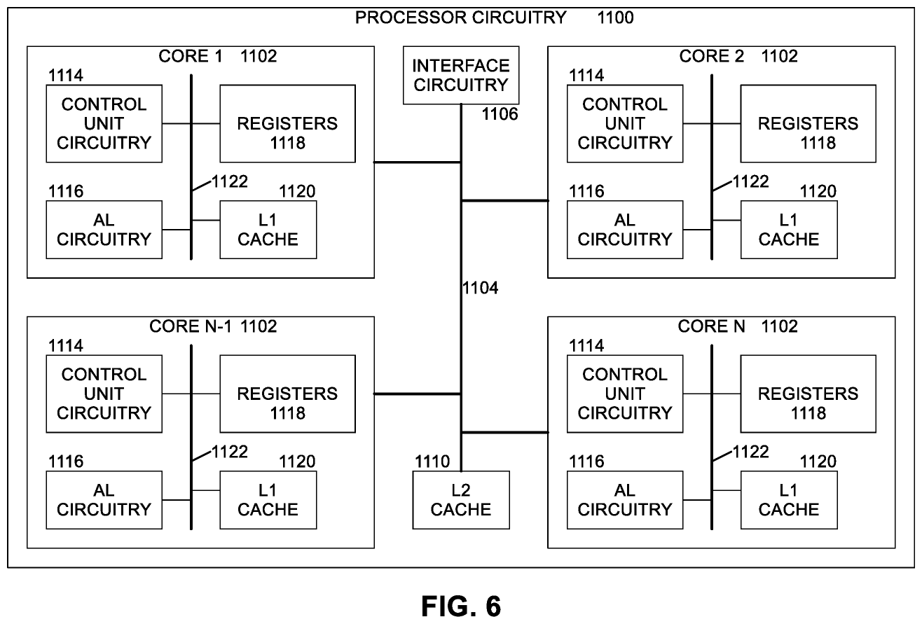

Flowcharts representative of example hardware logic circuitry, machine readable instructions, hardware implemented state machines, and/or any combination thereof is shown in FIGS. 2 and 4. The machine readable instructions may be one or more executable programs or portion(s) of an executable program for execution by processor circuitry, such as the processor circuitry 1012 shown in the example processor platform 1000 discussed below in connection with FIG. 5 and/or the example processor circuitry discussed below in connection with FIGS. 6 and/or 7. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The tangible machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 2 and 4, many other methods of implementing the example computing system may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2 and 4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a block diagram of an example processor platform 1000 structured to execute and/or instantiate the machine-readable instructions and/or operations of FIGS. 1-4. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices. In this example, processor circuitry 1012 implements the example processing device circuitry 102.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 (e.g., NVM 128) by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1032, which may be implemented by the machine-readable instructions of FIGS. 1-4, may be stored in the mass storage device 1028, in the volatile memory 1014, in the non-volatile memory 1016, and/or on a removable non-transitory computer readable storage medium such as a CD or DVD.

FIG. 6 is a block diagram of an example implementation of processor circuitry 1012 of FIG. 5. In this example, processor circuitry 1012 of FIG. 6 is implemented by a microprocessor 1100. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all the machine-readable instructions and/or operations represented by the flowchart of FIGS. 4.

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache in local memory 1120, and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 6. Alternatively, the registers 1118 may be organized in any other arrangement, format, or structure including distributed throughout the core 1102 to shorten access time. The bus 1104 may implement at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

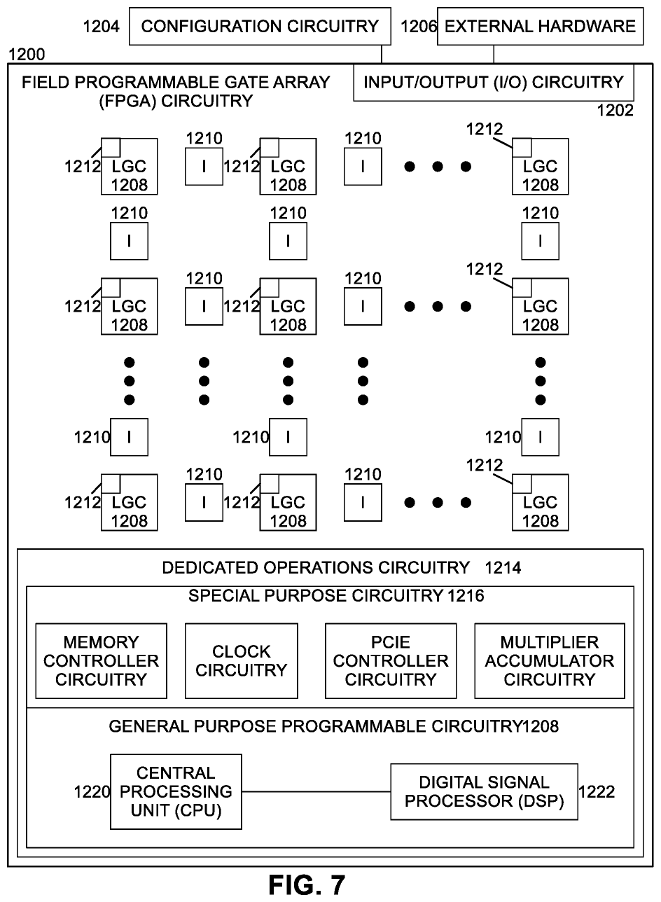

FIG. 7 is a block diagram of another example implementation of the processor circuitry 1012 of FIG. 5. In this example, processor circuitry 1012 is implemented by FPGA circuitry 1200. The FPGA circuitry 1200 can be used, for example, to perform operations that could otherwise be performed by the example microprocessor 1100 of FIG. 6 executing corresponding machine-readable instructions. However, once configured, the FPGA circuitry 1200 instantiates the machine-readable instructions in hardware and, thus, can often execute the operations faster than they could be performed by a general-purpose microprocessor executing the corresponding software.

More specifically, in contrast to the microprocessor 1100 of FIG. 6 described above (which is a general purpose device that may be programmed to execute some or all of the machine readable instructions represented by the flowcharts of FIGS. 2 and 4 but whose interconnections and logic circuitry are fixed once fabricated), the FPGA circuitry 1200 of the example of FIG. 7 includes interconnections and logic circuitry that may be configured and/or interconnected in different ways after fabrication to instantiate, for example, some or all of the machine readable instructions represented by the flowcharts of FIGS. 2 and 4. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowcharts of

FIGS. 2 and 4. As such, the FPGA circuitry 1200 may be structured to effectively instantiate some or all the machine-readable instructions of the flowcharts of FIGS. 2 and 4 as dedicated logic circuits to perform the operations corresponding to those software instructions in a dedicated manner analogous to an ASIC. Therefore, the FPGA circuitry 1200 may perform the operations corresponding to the some or all the machine-readable instructions of FIGS. 2 and 4 faster than the general-purpose microprocessor can execute the same.

In the example of FIG. 7, the FPGA circuitry 1200 is structured to be programmed (and/or reprogrammed one or more times) by an end user by a hardware description language (HDL) such as Verilog. The FPGA circuitry 1200 of FIG. 7, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 6. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine-readable instructions of FIG. 4 and/or other desired operations. The logic gate circuitry 1208 shown in FIG. 7 is fabricated in groups or blocks. Each block includes semiconductor-based electrical structures that may be configured into logic circuits. In some examples, the electrical structures include logic gates (e.g., AND gates, OR gates, NOR gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 7 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 6 and 7 illustrate two example implementations of the processor circuitry 1012 of FIG. 5, many other approaches are contemplated. For example, as mentioned above, modern FPGA circuitry may include an on-board CPU, such as one or more of the example CPU 1220 of FIG. 7. Therefore, the processor circuitry 1012 of FIG. 5 may additionally be implemented by combining the example microprocessor 1100 of FIG. 6 and the example FPGA circuitry 1200 of FIG. 7. In some such hybrid examples, a first portion of the machine-readable instructions represented by the flowcharts of FIGS. 2 and 4 may be executed by one or more of the cores 1102 of FIG. 6 and a second portion of the machine-readable instructions represented by the flowcharts of FIGS. 2 and 4 may be executed by the FPGA circuitry 1200 of FIG. 7.

In some examples, the processor circuitry 1012 of FIG. 5 may be in one or more packages. For example, the microprocessor 1100 of FIG. 6 and/or the FPGA circuitry 1200 of FIG. 7 may be in one or more packages. In some examples, an XPU may be implemented by the processor circuitry 1012 of FIG. 5, which may be in one or more packages. For example, the XPU may include a CPU in one package, a DSP in another package, a GPU in yet another package, and an FPGA in still yet another package.

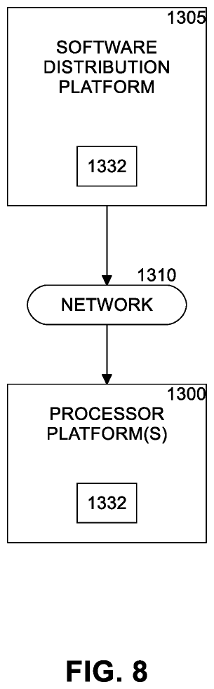

A block diagram illustrating an example software distribution platform 1305 to distribute software such as the example machine readable instructions 1032 of FIG. 5 to hardware devices owned and/or operated by third parties is illustrated in FIG. 8. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 5. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine readable instructions, as described above. The one or more servers of the example software distribution platform 1305 are in communication with a network 1310, which may correspond to any one or more of the Internet and/or any of the example networks, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine readable instructions described above, may be downloaded to the example processor platform 1300, which is to execute the machine-readable instructions 1032 to implement the methods described above and associated computing system 101. In some examples, one or more servers of the software distribution platform 1305 periodically offer, transmit, and/or force updates to the software (e.g., the example machine readable instructions 1032 of FIG. 5) to ensure improvements, patches, updates, etc., are distributed and applied to the software at the end user devices.

In some examples, an apparatus includes means for data processing of FIGS. 1-4. For example, the means for processing may be implemented by processor circuitry, processor circuitry, firmware circuitry, etc. In some examples, the processor circuitry may be implemented by machine executable instructions executed by processor circuitry, which may be implemented by the example processor circuitry 1012 of FIG. 5, the example microprocessor 1100 of FIG. 6, and/or the example Field Programmable Gate Array (FPGA) circuitry 1200 of FIG. 7. In other examples, the processor circuitry is implemented by other hardware logic circuitry, hardware implemented state machines, and/or any other combination of hardware, software, and/or firmware. For example, the processor circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

The following examples pertain to further embodiments. Specifics in the examples may be used anywhere in one or more embodiments. Example 1 is an apparatus including a non-volatile memory (NVM); provisioning circuitry to receive a provision key and provision data encrypted with the provision key, and to store the encrypted provision data in the NVM; exclusive-OR (XOR) circuitry to perform an XOR operation on the provision key and a physically unclonable function (PUF) mask to generate a masked provision key; and encryption circuitry to encrypt the masked provision key with a PUF key to generate an encrypted provision key; wherein the provisioning circuitry to store the encrypted provision key in the NVM.

In Example 2, the subject matter of Example 1 optionally includes wherein the apparatus comprises a processing device and the encrypted provision data comprises encrypted processing device specific information. In Example 3, the subject matter of Example 2 optionally includes wherein the processing device comprises a processor. In Example 4, the subject matter of Example 2 optionally includes wherein the encrypted processing device specific information comprises an identifier (ID) of the processing device. In Example 5, the subject matter of Example 1 optionally includes PUF circuitry to generate the PUF mask and the PUF key. In Example 6, the subject matter of Example 5 optionally includes wherein a number of bits of the PUF key equals a number of bits of the provision key. In Example 7, the subject matter of Example 5 optionally includes wherein the PUF mask and the PUF key comprises random bit strings. In Example 8, the subject matter of Example 1 optionally includes wherein the provision key comprises an Advanced Encryption Standard (AES) key. In Example 9, the subject matter of Example 1 optionally includes true random number generator (TRNG) circuitry to generate the PUF mask and the PUF key. In Example 10, the subject matter of Example 1 optionally includes wherein the masked provision key comprises a random key split.

Example 11 is a method including receiving a provision key and provision data encrypted with the provision key; generating a physically unclonable function (PUF) mask and a PUF key; generating a masked provision key from the provision key and the PUF mask; encrypting the masked provision key with the PUF key to generate an encrypted provision key; storing the encrypted provision key in a non-volatile memory (NVM); and storing the encrypted provision data in the NVM.

In Example 12, the subject matter of Example 11 optionally includes wherein the encrypted provision data comprises encrypted processing device specific information. In Example 13, the subject matter of Example 11 optionally includes wherein the encrypted processing device specific information comprises an identifier (ID) of a processing device. In Example 14, the subject matter of Example 11 optionally includes wherein a number of bits of the PUF key is equals a number of bits of the provision key. In Example 15, the subject matter of Example 11 optionally includes wherein the PUF mask and the PUF key comprise random bit strings. In Example 16, the subject matter of Example 11 optionally includes wherein the masked provision key comprises a random key split.

Example 17 is a system including a computing system to generate a provision key and provision data, and to encrypt the provision data using the provision key; and a processing device including a non-volatile memory (NVM); provisioning circuitry to receive the provision key and the encrypted provision data from the computing system, and to store the encrypted provision data in the non-volatile memory; exclusive-OR (XOR) circuitry to perform an XOR operation on the provision key and a physically unclonable function (PUF) mask to generate a masked provision key; and encryption circuitry to encrypt the masked provision key with a PUF key to generate an encrypted provision key; wherein the provisioning circuitry to store the encrypted provision key in the NVM.

In Example 18, the subject matter of Example 17 optionally includes wherein the encrypted provision data comprises encrypted processing device specific information. In Example 19, the subject matter of Example 18 optionally includes wherein the encrypted processing device specific information comprises an identifier (ID) of the processing device. In Example 20, the subject matter of Example 17 optionally includes wherein the processing device comprises PUF circuitry to generate the PUF mask and the PUF key.

Example 21 is an apparatus operative to perform the method of any one of Examples 11 to 16. Example 22 is an apparatus that includes means for performing the method of any one of Examples 11 to 16. Example 23 is an apparatus that includes any combination of modules and/or units and/or logic and/or circuitry and/or means operative to perform the method of any one of Examples 11 to 16. Example 24 is an optionally non-transitory and/or tangible machine-readable medium, which optionally stores or otherwise provides instructions that if and/or when executed by a computer system or other machine are operative to cause the machine to perform the method of any one of Examples 11 to 16.

From the foregoing, it will be appreciated that example systems, methods, apparatus, and articles of manufacture have been disclosed that provide improved security in a computing system. The disclosed systems, methods, apparatus, and articles of manufacture improve the security of using a plurality of fuses and a non-volatile memory in the computing system to enable owner-provided provisioning of provisioning information (including owner identity or processing device identity information). The disclosed systems, methods, apparatus, and articles of manufacture are accordingly directed to one or more improvement(s) in the operation of a machine such as a computer or other electronic and/or mechanical device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the examples of this patent.

What is claimed is:

1. An apparatus comprising:
a non-volatile memory (NVM);
provisioning circuitry to receive a provision key and provision data encrypted with the provision key, and to store the encrypted provision data in the NVM;
exclusive-OR (XOR) circuitry to perform an XOR operation on the provision key and a physically unclonable function (PUF) mask to generate a masked provision key; and
encryption circuitry to encrypt the masked provision key with a PUF key to generate an encrypted provision key;
wherein the provisioning circuitry to store the encrypted provision key in the NVM.

2. The apparatus of claim 1, wherein the apparatus comprises a processing device and the encrypted provision data comprises encrypted processing device specific information.

3. The apparatus of claim 2, wherein the processing device comprises a processor.

4. The apparatus of claim 2, wherein the encrypted processing device specific information comprises an identifier (ID) of the processing device.

5. The apparatus of claim 1, comprising PUF circuitry to generate the PUF mask and the PUF key.

6. The apparatus of claim 5, wherein a number of bits of the PUF key equals a number of bits of the provision key.

7. The apparatus of claim 5, wherein the PUF mask and the PUF key comprises random bit strings.

8. The apparatus of claim 1, wherein the provision key comprises an Advanced Encryption Standard (AES) key.

9. The apparatus of claim 1, comprising true random number generator (TRNG) circuitry to generate the PUF mask and the PUF key.

10. The apparatus of claim 1, wherein the masked provision key comprises a random key split.

11. A method comprising:
receiving a provision key and provision data encrypted with the provision key;
generating a physically unclonable function (PUF) mask and a PUF key;
generating a masked provision key from the provision key and the PUF mask;
encrypting the masked provision key with the PUF key to generate an encrypted provision key;
storing the encrypted provision key in a non-volatile memory (NVM); and
storing the encrypted provision data in the NVM.

12. The method of claim 11, wherein the encrypted provision data comprises encrypted processing device specific information.

13. The method of claim 12, wherein the encrypted processing device specific information comprises an identifier (ID) of a processing device.

14. The method of claim 11, wherein a number of bits of the PUF key is equals a number of bits of the provision key.

15. The method of claim 11, wherein the PUF mask and the PUF key comprise random bit strings.

16. The method of claim 11, wherein the masked provision key comprises a random key split.

17. A system comprising:
a computing system to generate a provision key and provision data, and to encrypt the provision data using the provision key; and
a processing device including
a non-volatile memory (NVM);
provisioning circuitry to receive the provision key and the encrypted provision data from the computing system, and to store the encrypted provision data in the non-volatile memory;
exclusive-OR (XOR) circuitry to perform an XOR operation on the provision key and a physically unclonable function (PUF) mask to generate a masked provision key; and
encryption circuitry to encrypt the masked provision key with a PUF key to generate an encrypted provision key;
wherein the provisioning circuitry to store the encrypted provision key in the NVM.

18. The system of claim 17, wherein the encrypted provision data comprises encrypted processing device specific information.

19. The system of claim 18, wherein the encrypted processing device specific information comprises an identifier (ID) of the processing device.

20. The system of claim 17, wherein the processing device comprises PUF circuitry to generate the PUF mask and the PUF key.
